(19) United States
(12) Patent Application Publication
(10) Pub. No.: US 2024/0165811 A1
(43) Pub. Date: May 23, 2024

(54) DEVICE FOR SETTING SAFETY PARAMETERS, TEACHING DEVICE AND METHOD

(71) Applicant: FANUC CORPORATION, Yamanashi (JP)

(72) Inventors: Nao OOSHIMA, Yamanashi (JP); Gou INABA, Yamanashi (JP)

(21) Appl. No.: 18/552,667

(22) PCT Filed: Apr. 28, 2021
(86) PCT No.: PCT/JP2021/017077

§ 371 Date: Sep. 27, 2023

(51) Int. Cl. B25J 9/16

(52) U.S. Cl. CPC B25J 9/1674; B25J 9/1666

(57) ABSTRACT

Conventionally, it was necessary for an operator with specialized knowledge to set safety parameters for a safety function one at a time from the beginning, so there was a demand to simplify operations for setting safety parameters. This device is provided with a parameter setting unit which sets safety parameters for ensuring the safety of an operation by an industrial machine, a storage unit which stores samples of safety parameters prepared in advance, an input receiving unit which receives input for selecting a sample stored in the storage unit, and an import unit which reads out the selected sample from the storage unit and imports this to the parameter setting unit. The parameter setting unit sets the imported sample as the new safety parameters.

### TECHNICAL FIELD

The present disclosure relates to a device, a teaching device and a method of setting a safety parameter.

### BACKGROUND ART

There is known a system that implements safety functions for ensuring the safety of robot work (e.g., Patent Document 1).

### CITATION LIST

### Patent Literature

Patent Document 1: JP 2020-157462 A

### SUMMARY OF INVENTION

### Technical Problem

In the related art, when building a new mechanical system, an operator skilled in the art needs to set the safety parameters for safety functions which needs to be set from the beginning one by one. There is a need to simplify the setting work of such safety parameters.

### Solution to Problem

In one aspect of the present disclosure, a device includes: a parameter setting section configured to set a safety parameter for ensuring safety of work performed by a machine; a storage configured to store a sample of the safety parameter, which is, prepared in advance; an input receiving section configured to receive an input for selecting the sample stored in the storage; and an import section configured to read out from the storage the sample selected through the input receiving section, and import the read sample to the parameter setting section.

The parameter setting section sets the imported sample as a new safety parameter.

In one aspect of the present disclosure, a method of setting a safety parameter for ensuring safety of work performed by a machine, includes: storing a sample prepared in advance of the safety parameter in a storage; and performing, by a processor, a function of setting the safety parameter; receiving, by a processor, an input for selecting the sample stored in the storage; reading out the sample selected by the input from the storage and importing the selected sample to the function; and setting the imported sample as a new safety parameter.

### Advantageous Effect of the Invention

According to the present disclosure, an operator can easily build a framework of safety parameters for a real machine by simply selecting a desired sample from among samples prepared in advance according to the machine. Thus, the work of setting the safety parameter is greatly simplified compared to the methods in the related art of setting the safety parameter from the beginning one by one.

### BRIEF DESCRIPTION OF DRAWINGS

FIG. 1 is a diagram of a mechanical system according to one embodiment.

FIG. 2 is a block diagram of the mechanical system illustrated in FIG. 1.

FIG. 3 illustrates an example of a limited area.

FIG. 4 illustrates another example of a limited area.

FIG. 5 illustrates an example of a plurality of limited areas contained in a composite sample.

FIG. 6 illustrates an example of a sample set selection image.

FIG. 7 illustrates an example of a sample selection image.

FIG. 8 illustrates an example of a sample description image.

FIG. 9 illustrates an example of a sample import image.

FIG. 10 illustrates an example of a sample adjusting image.

FIG. 11 illustrates another example of a sample description image.

FIG. 12 illustrates another example of a sample import image.

FIG. 13 illustrates another example of a sample adjusting image.

FIG. 14 illustrates still another example of a sample adjusting image.

FIG. 15 illustrates still another example of a sample adjusting image.

FIG. 16 illustrates an example of a sample list image.

FIG. 17 is a diagram of a network system according to one embodiment.

### DESCRIPTION OF EMBODIMENTS

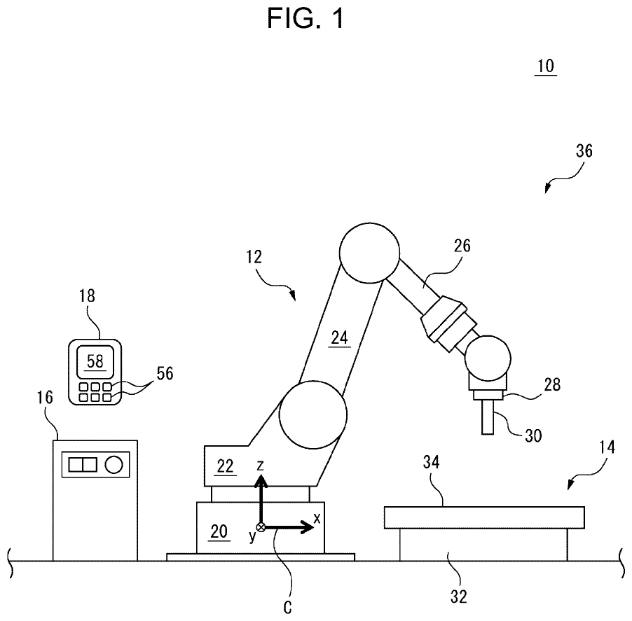

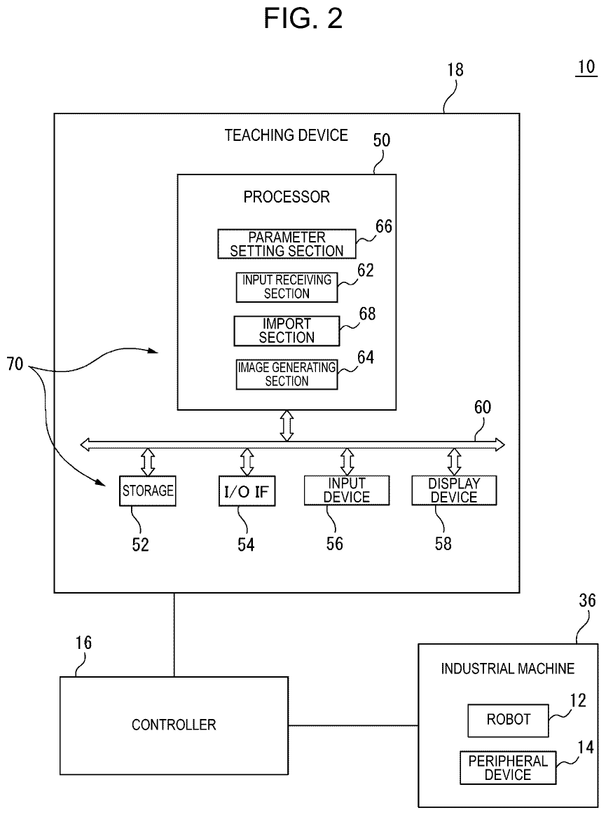

Embodiments of the present disclosure will be described in detail below based on the drawings. Note that, in the various embodiments described below, similar elements are denoted by the same signs, and redundant descriptions are omitted. First, a mechanical system 10 according to one embodiment will be described with reference to FIGS. 1 and 2. The mechanical system 10 performs predetermined work (workpiece handling, machining, welding, or the like) to a workpiece.

Specifically, the mechanical system 10 includes a robot 12, a peripheral device 14, a controller 16, and a teaching device 18. In the present embodiment, the robot 12 is a vertical articulated type robot and includes a robot base 20, a rotary barrel 22, a lower arm 24, an upper arm 26, a wrist 28, and an end effector 30.

The robot base 20 is fixed on a floor of a work cell. The rotary barrel 22 is provided at the robot base 20 so as to be rotatable about the vertical axis. The lower arm 24 is provided at the rotary barrel 22 so as to be rotatable about the horizontal axis. The upper arm 26 is rotatably provided at a distal end of the lower arm 24. The wrist 28 is rotatably provided at a distal end of the upper arm 26.

The end effector 30 is detachably attached to a distal end (so-called wrist flange) of the wrist 28. The end effector 30 is, for example, a robot hand capable of gripping the workpiece, a welding torch or a welding gun for welding the workpiece, or a tool for machining the workpiece, or the like, and performs work (workpiece handling, welding, machining) on the workpiece.

The robot base 20, the rotary barrel 22, the lower arm 24, the upper arm 26, and the wrist 28 are each provided with a plurality of servomotors (not illustrated) that rotate each movable element (i.e., rotary barrel 22, lower arm 24, upper arm 26, wrist 28) of the robot 12 in response to a command from the controller 16, thereby moving the end effector 30 to any position.

The robot 12 is configured with a robot coordinate system C. The robot coordinate system C is a coordinate system for automatically controlling each movable element of the robot 12. In the present embodiment, the robot coordinate system C is set with respect to the robot 12 such that the origin of the robot coordinate system C is arranged at the center of the robot base 20 and the z-axis of the robot coordinate system C coincides with the rotary axis of the rotary barrel 22.

The peripheral device 14 is arranged around the robot 12. The peripheral device 14 is, for example, a conveyor for transporting a workpiece in one direction or a workpiece table device for moving an installed workpiece in the x-y plane of the robot coordinate system C, and includes a base 32 fixed to a work cell, a movable section 34 movably provided on the base 32, and a servomotor (not illustrated) for driving the movable part 34.

The peripheral device 14 moves the movable part 34 by driving the servo motor in response to a command from the controller 16, thereby performing work (workpiece transfer work, etc.) different from that of the robot 12 on the workpiece. Thus, the robot 12 and the peripheral device 14 work together on the workpiece. Thus, the robot 12 and the peripheral device 14 constitute a machine 36 (specifically, industrial machine) that performs work on the workpiece.

The controller 16 controls the operation of the machine 36 (the robot 12 and the peripheral device 14). Specifically, the controller 16 is a computer including a processor (CPU, GPU, or the like), a storage (ROM, RAM), or the like. The processor of the controller 16 generates commands to each servo motor of the machine 36 (the robot 12 and the peripheral device 14) according to the operation program OP and operates the machine 36.

The teaching device 18 teaches an operation to the machine 36. Specifically, as illustrated in FIG. 2, the teaching device 18 is a computer including a processor 50, a storage 52, an I/O interface 54, an input device 56, and a display device 58. The processor 50 includes a CPU or GPU, or the like, and is communicably connected to the storage 52, the I/O interface 54, the input device 56, and the display device 58 via a bus 60, and performs arithmetic processing to set a safety parameter described later while communicating with these components.

The storage 52 includes a RAM or a ROM, or the like, and temporarily or permanently stores various data used in the arithmetic processing executed by the processor 50 and various data generated during the arithmetic processing. The I/O interface 54 includes, for example, an Ethernet (trade name) port, a USB port, an optical fiber connector, or an HDMI (trade name) terminal, and communicates data by wire or wirelessly with an external device under a command from the processor 50.

In the present embodiment, the controller 16 is communicably connected to the I/O interface 54. The input device 56 includes a push button, a keyboard, a mouse, or a touch panel, or the like, and receives data input from an operator. The display device 58 includes a liquid crystal display or an organic EL display, or the like, and displays various data in a visually recognizable manner.

Here, when the machine 36 is performing work, a safety function limiting the operation of the machine 36 (e.g., robot 12) may be performed in order to ensure the safety of the work. For such a safety function, a safety parameter SP is set for the machine 36. The safety parameter SP includes a limitation parameter RP defining a limited area RE and a limited speed V or the like of the machine 36 (e.g., robot 12), and model data MD of the machine 36 (robot 12).

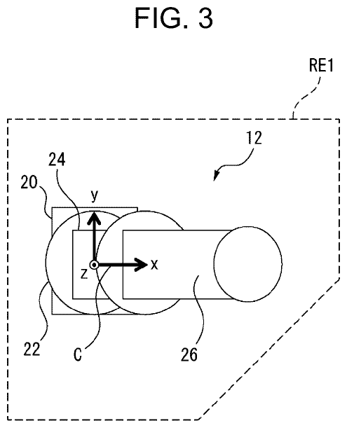

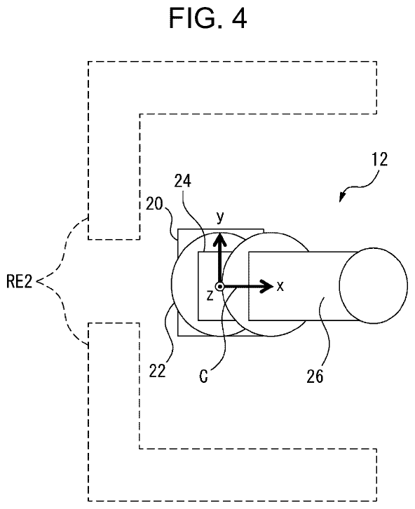

The limitation parameter RP will be described below with reference to FIGS. 3 and 4. FIG. 3 illustrates a limited area RE1 where the robot 12 is allowed to enter during work. When the limited area RE1 is set for the robot 12, the robot 12 is allowed to move a part set as a monitoring target (e.g., end effector 30) inside the limited area RE1, but is prohibited to move the part outside the limited area RE1. Supposing that the robot 12 moves the monitoring target part outside the limited area RE1 during work, the controller 16 brings the robot 12 to an emergency stop.

Alternatively, when the robot 12 moves the monitoring target part outside the limited area RE1 during work, the controller 16 may reduce an operating speed V of the robot 12 (specifically, of the monitoring target part) from a normal speed V0 determined as a work requirement to a lower limited speed V1 (<V0) and also moves the monitoring target part away along a predetermined retraction path PT.

FIG. 4 illustrates a limited area RE2 where the robot 12 is prohibited to enter during work. When the limited area RE2 is set for the robot 12, the robot 12 is prohibited to move a monitoring target part inside the limited area RE2, while it is allowed to move outside the limited area RE2.

When the robot 12 moves the monitoring target part inside the limited area RE2 during work, the controller 16 either brings the robot 12 to an emergency stop or reduces the operating speed V of the robot 12 from the normal speed V0 to the limited speed V1 and moves the robot 12 away along the retraction path PT. Each of the limited areas RE1 and RE2 can be determined as a group of coordinates P1 (x₁, y₁, z₁), P2 (x₂, y₂, z₂), . . . Pa (xₙ, yₙ, zₙ) of the robot coordinate system C.

On the other hand, in addition to the limited area RE (RE1 or RE2), a limited speed V2 determining the maximum allowable speed during work is set for the robot 12. For example, the controller 16 brings the robot 12 to an emergency stop when the part (end effector 30) of the robot 12 set as the monitoring target exceeds the limited speed V2. Alternatively, the controller 16 may reduce the operating speed V of the monitoring target part to less than or equal to the limited speed V2 when the monitoring target part exceeds the limited speed V2. These limited areas RE1 and RE2, the limited speeds V1 and V2, and the retraction path PT constitute the limitation parameter RP.

The model data MD is used to set the machine 36 to be monitored for the limitation parameter RP, and includes machine information MD1 indicating the type, dimensions, or specifications, or the like of the machine 36, and machine model MD2 modeling the machine 36 (the robot 12, the peripheral device 14), or the like.

Specifically, the machine information MD1 of the robot 12 includes an identification number ID (product number, or the like) that identifies the type of a main body of the robot 12 (assembly of, the robot base 20, the rotary barrel 22, the lower arm 24, the upper arm 26, and the wrist 28). In addition, the machine information MD1 of the robot 12 includes, as a specification of the main body of the robot 12, a distance d_{MAX} from the origin of the robot coordinate system C to a maximum arrival point (i.e., maximum arrival distance) where the robot 12 can reach the end effector 30.

The machine information MD1 of the robot 12 may also include information on the type, specification, dimensions, or mounting position of the end effector 30. On the other hand, a machine model MD2 includes a machine model MD2_₁ for the main body of the robot 12 and a machine model MD2_₂ for the end effector 30. The machine model MD2_₁ for the main body of the robot 12 includes at least one of drawing data MD2__{1A} (e.g., three-dimensional CAD data) of the main body of the robot 12 or a monitoring model MD2__{1B} representing the monitoring target of the main body. The monitoring model MD2__{1B} is set to the main body so as to include a part (e.g., wrist) of the main body of the robot 12 and is data for schematically representing the part of the main body to be monitored.

Further, the machine model MD2_₂ for the end effector 30 includes at least one of drawing data MD2__{2A} (e.g., three-dimensional CAD data) of the end effector 30 and a monitoring model MD2__{2B} representing a monitoring target of the end effector 30. The monitoring model MD2__{2B} is set to the end effector 30 so as to include a part of the end effector 30 (e.g., finger or suction part) of the robot 12, and is data for schematically representing a part of the end effector 30 to be monitored.

The limitation parameter RP and the model data MD are set as the safety parameter SP for the safety function. In the present embodiment, an operator operates the teaching device 18 to set these safety parameters SP (the limited area RE, the limited speed V, the model data MD, or the like).

The method of setting the safety parameter SP will be described below. Here, in the present embodiment, the storage 52 stores a plurality of samples SP′ of the safety parameter SP prepared in advance. Specifically, the storage 52 stores in advance, as the sample SP′, a sample (limit value sample) RP′ of the limitation parameter RP, a sample (model sample) MD′ of the model data MD, and a composite sample CS.

The limit value sample RP′ includes a sample (limit value sample) RE1′ of the limited area RE1, a sample (limit value sample) RE2′ of the limited area RE2, a sample (limit value sample) V of the limited speed V1 or V2, and a sample (limit value sample) PT′ of the retraction path PT. The limit value samples RE1′ and RE2′ are samples of a group of coordinates (xₙ, yₙ, zₙ) (n=1, 2, 3 . . . ) of the robot coordinate system C determining the limited areas RE1 and RE2, respectively, and a plurality of limit value samples RE1′ and RE2′, including different coordinate group (xₙ, yₙ, zₙ) from each other, are stored in the storage 52.

For example, the storage 52 stores, as a plurality of limit value samples RE1′ (or RE2′): a first group of coordinates (x_{1_1}, y_{1_1}, z_{1_1}) to (x_{n_1}, y_{n_1}, z_{n_1}) determining a first limit value sample RE1′_₁ (or RE2′_₁); a second group of coordinates (x_{1_2}, y_{1_2}, z_{1_2}) to (x_{n_2}, y_{n_2}, z_{n_2}) defining a second limit value sample RE1′_₂ (or RE2′_₂); and a m-th group of coordinates (x_{1_m}, y_{1_m}, z_{1_m}) to (x_{n_m}, y_{n_m}, z_{n_m}) . . . determining an m-th limit value sample RE1′_ₘ (or RE2′_m).

In addition, a plurality of limit value samples V′ that are different from each other are stored in the storage 52 as a value of speed V. For example, the storage 52 stores a first limit value sample V′_₁=10 [m/sec], a second limit value sample V′_₂=20 [m/sec], . . . , an m-th limit value sample V′_ₘ=100 [m/sec]. Further, the storage 52 stores a first limit value sample PT′_₁, a second limit value sample PT′_₂, and . . . an m-th limit value sample PT′_m. The limit value sample PT′ is represented, for example, as a coordinate of the coordinate system C.

In the present embodiment, the model sample MD′ includes the machine information MD1 of the end effector 30 of the robot 12 and the machine model MD2_₂ (specifically, drawing data MD2__{2A} and monitoring model MD2_2B) of the end effector 30. The different various model samples MD′ are stored in the storage 52. The model sample MD′ includes, for example, a group of model samples MD′₁ of a robot hand 30A gripping an object with a plurality of fingers, a group of model samples MD′₂ of a robot hand 30B gripping an object with a suction part (e.g., electromagnet, sucking disc or vacuum device), a group of model samples MD′₃ of a welding torch 30C, and a group of model samples MD′₄ of a welding gun 30D.

For example, the storage 52 stores a group of model samples MD′_{1_1}, MD′_{1_2}, . . . MD′_{1_m} of the robot hand 30A, a group of model samples MD′_{2_1}, MD′_{2_2}, . . . MD′_{2_m} of the robot hand 30B, a group of model samples MD′_{3_1}, MD′_{3_2}, . . . MD′_{3_m} of the welding torch 30C, and a group of model samples MD′_{4_1}, MD′_{4_2}, . . . MD′_{4_m} of the welding gun 30D.

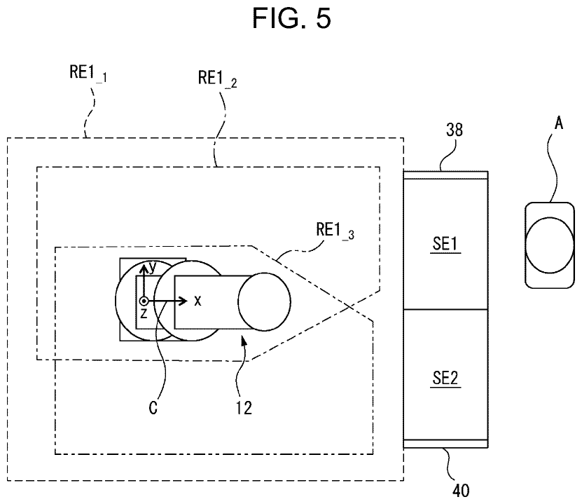

The composite sample CS is a single sample that contains combined data of a plurality of safety parameters SP. This composite sample CS will be described with reference to FIG. 5. FIG. 5 illustrates an example of a work cell in which the robot 12 is arranged. In the example illustrated in FIG. 5, as the limited area where the robot 12 is allowed to enter, the first limited area RE1_₁ indicated by a broken line, the second limited area RE1_₂ indicated by a single dot-dash line, and the third limited area RE1_₃ indicated by a double dot-dash line are set so as to surround the robot 12.

The first limited area RE1_₁ defines the outermost edge of the permissible operating range of the robot 12 during work, and is set, for example, to prohibit the robot 12 from moving outside the first limited area RE1_₁ during the entire work process. The second limited area RE1_₂ is arranged inside the first limited area RE1_₁ on the y-axis plus direction side of the robot coordinate system C as viewed from the robot 12. On the other hand, the third limited area RE1_3 is arranged inside the first limited area RE1_₁ on the y-axis minus direction side of the robot coordinate system C as viewed from the robot 12.

Further, in the example illustrated in FIG. 5, two sensor detection areas SE1 and SE2 are set adjacent to the x-axis plus direction side of the robot coordinate system C with respect to the first limited area RE1_1. The sensor detection area SE1 is defined, for example, by a first object detection sensor 38 that can detect the entry of an object in a non-contact manner, and is placed adjacent on the x-axis plus direction side of the robot coordinate system C with respect to the second limited area RE1_2.

When detecting that an operator A enters (or approaches) a sensor detection area SE1, the first object detection sensor 38 sets a safety signal S1 to “ON” (or “1”) and sends the signal to the controller 16. Then, when the operator A exits (or leaves) the sensor detection area SE1, the first object detection sensor 38 sets the safety signal S1 to “OFF” (or “0”).

On the other hand, a sensor detection area SE2 is located adjacent to the y-axis minus direction side of the robot coordinate system C from the sensor detection area SE1, and adjacent to the x-axis plus direction side of the robot coordinate system C with respect to the third limited area RE1_₃. The sensor detection area SE2 is defined, for example, by a second object detection sensor 40 that can detect the entry of an object in a non-contact manner. When detecting the entry (or approach) of the operator A into the sensor detection area SE2, the second object detection sensor 40 sets a safety signal S2 to “ON” and sends the signal to the controller 16, and when the operator A exits (or leaves) the sensor detection area SE2, the second object detection sensor 40 sets the safety signal S2 to “OFF”.

In the work cell illustrated in FIG. 5, the operator A may perform work (e.g., workpiece handling between the operator A and the robot 12) in collaboration with the robot 12. In such a case, the controller 16 performs the following safety function as an example. Specifically, the controller 16 makes first limited area RE1_₁ valid for the entire duration of the work and prohibits the robot 12 from moving outside of the first limited area RE1_₁ during the entire process of the work.

When the operator A enters (or approaches) the sensor detection area SE1 during the work and the safety signal S1 received from the first object detection sensor 38 becomes “ON”, the controller 16 makes the third limited area RE1_₃ valid and prohibits the robot 12 from moving outside the third limited area RE1_₃.

This prevents the robot 12 from entering the y-axis plus direction side of the robot coordinate system C (i.e., the side where the operator A is present), thereby preventing the robot 12 from colliding with the operator A. Then, when the operator A exits (or leaves) from the sensor detection area SE1 and the safety signal S1 from the first object detection sensor 38 becomes “OFF”, the controller 16 invalidates the third limited area RE1_₃.

On the other hand, when the operator A enters (or approaches) the sensor detection area SE2 and the safety signal S2 received from the second object detection sensor 40 becomes “ON”, the controller 16 makes the second limited area RE1_2 valid and prohibits the robot 12 from moving outside the second limited area RE1_₂. This prevents the robot 12 from entering the y-axis minus direction side of the robot coordinate system C (i.e., the side where the operator A is present), thereby preventing the robot 12 from colliding with the operator A. Then, when the operator A exits (or leaves) from the sensor detection area SE2 and the safety signal S2 from the second object detection sensor 40 becomes “OFF”, the controller 16 invalidates the second limited area RE1_₂.

Thus, a safety function may be performed by using a combination of a plurality of safety parameters SP (limited area RE1_₁, RE1_₂, RE1_₃). The combined data of the plurality of safety parameters SP is contained in the composite sample CS, and the storage 52 stores a plurality of composite samples CS₁, CS₂, and . . . CSₘ, each of which is various combinations of the safety parameters SP.

Specifically, the composite sample CSₘ contains, for example, the data of the first limited area RE1_₁ (a group of coordinates), the data of the second limited area RE1_₂, the data of the third limited area RE1_₃, and the machine model MD2 for the robot 12 which are illustrated in FIG. 5, in combination. The data of the limited areas RE1_₁, RE1_₂ and RE1_₃ contained in the composite sample CSₘ constitute the limit value sample RE1′. The composite sample CSₘ may further include a limited area switching information SI for determining the relationship between “ON”/“OFF” of the safety signals ST and S2 and the validity/invalidity of the second limited area RE1_₂ and the third limited area RE1_₃.

Here, in the present embodiment, the storage 52 stores a plurality of sample sets SS (sample sets SS₁, SS₂, . . . SSₘ), each of which contains one limit value sample RE1′, one limit value sample RE2′, one model sample MD′, and one composite sample CS. For example, one sample set SSₘ contains a set of the above-described limit value sample RE1′_m, limit value sample RE2′_m, model sample MD′_{1_m}, and composite sample CSₘ. Note that only one of the limit value sample RE1′, the limit value sample RE2′, the model sample MD′, and the composite sample CS may be contained in the sample set SS.

As described above, a plurality of types of samples SP′ (the limit value sample RE1′, the limit value sample RE2′, the model sample MD′ and the composite sample CS) are contained in the sample set SS. The storage 52 stores a plurality of sample sets SS₁, SS₂, and . . . SSₘ, each containing various combinations of the sample SP′.

The various types of samples SP′ (limit value samples RE1′, RE2′ and V, model sample MD′, composite sample CS) and the sample set SS described above are created in advance as data of a first format FM1 (extension:“.abc”) by using, for example, a different computer from the teaching device 18, and stored in a first storage area 52A of the storage 52.

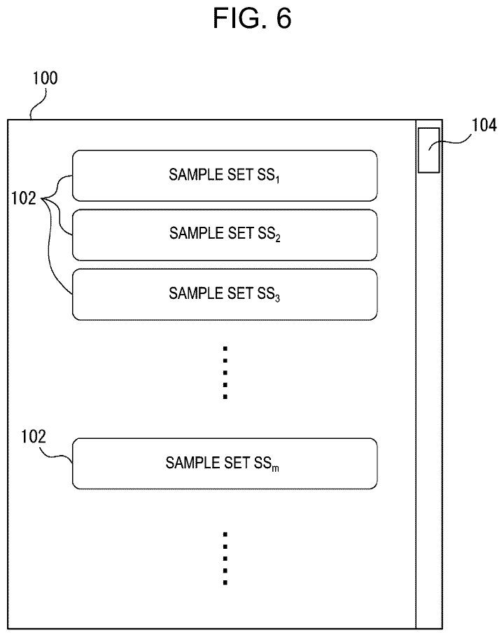

The operator sets the safety parameter SP based on these samples SP′ and sample set SS. When starting the setting of the safety parameter SP, the operator operates the input device 56 to give a setting start command to the processor 50 of the teaching device 18. When receiving the setting start command through the input device 56, the processor 50 first generates image data of a sample set selection image 100 illustrated in FIG. 6 and displays the image data on the display device 58.

The sample set selection image 100 is a graphical user interface (GUI) that allows the operator to select the sample set SS, and is generated as computer graphics (CG) image data. In the example illustrated in FIG. 6, the sample set selection image 100 includes a plurality of sample set selection button images 102 and a scroll bar image 104. The plurality of sample set selection button images 102 are respectively associated with the sample set SS₁, SS₂, and . . . SSₘ which are stored in the storage 52.

The operator can select the sample set SS associated with a clicked sample set selection button image 102 by operating the input device 56 and clicking one of the sample set selection button images 102 on the image. Further, the operator can change the sample set SS displayed by operating the input device 56 and sliding the scroll bar image 104 up and down on the image.

The information of the corresponding sample set SS (e.g., a brief description or drawing of the stored samples RE1′, RE2′, MD′, and CS) may be displayed in the sample set selection button image 102. The case where the operator operates the input device 56 and clicks the sample set selection button image 102 of the sample set SSₘ will be described below.

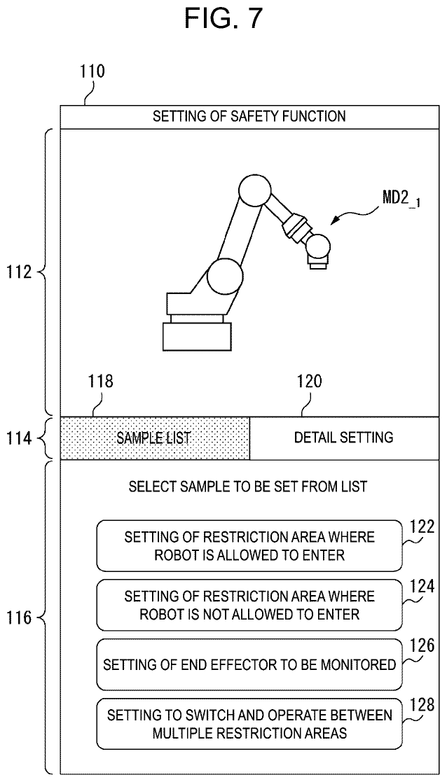

In this case, the processor 50 receives, from the input device 56, an input IP1 for selecting the sample set SSₘ. Thus, in the present embodiment, the processor 50 functions as an input receiving section 62 (FIG. 2) that receives the input IP1. When receiving the input IP1, the processor 50 generates image data of a sample selection image 110 illustrated in FIG. 7 and displays the generated image on the display device 58. The sample selection image 110 is a GUI that enables the operator to select a sample SP′ contained in the sample set SSₘ, and is generated as image data of CG.

In the example illustrated in FIG. 7, the sample selection image 110 includes a first image area 112, a second image area 114, and a third image area 116. The first image area 112 displays a machine model MD2_₁ (e.g., drawing data MD2__{1A}) of the main body of the robot 12. On the other hand, the third image area 116 displays a button image 122 for selecting the limit value sample RE1′, a button image 124 for selecting the limit value sample RE2′, a button image 126 for selecting the model sample MD′ to be monitored, and a button image 128 for selecting the composite sample CS.

The operator can select the sample SP′ to be imported from among the limit value sample RE1′, the limit value sample RE2′, the model sample MD′, and the composite sample CS by operating the input device 56 and clicking one of the button images 122, 124, 126 and 128 on the image. Importing sample SP′ will be described later.

On the other hand, a sample list image 118 and a detail setting image 120 are displayed in the second image area 114. As illustrated in FIG. 7, when the button images 122, 124, 126, and 128 for selecting the sample SP′ are displayed in the third image area 116, the sample list image 118 is highlighted.

When an operator operates the input device 56 and selects the limit value sample RE1′, the limit value sample RE2′, the model sample MD′, or the composite sample CS on the image, the processor 50 functions as the input receiving section 62 and receives an input IP2 through the input device 56 to select the limit value sample RE1′, the limit value sample RE2′, the model sample MD′, or the composite sample CS.

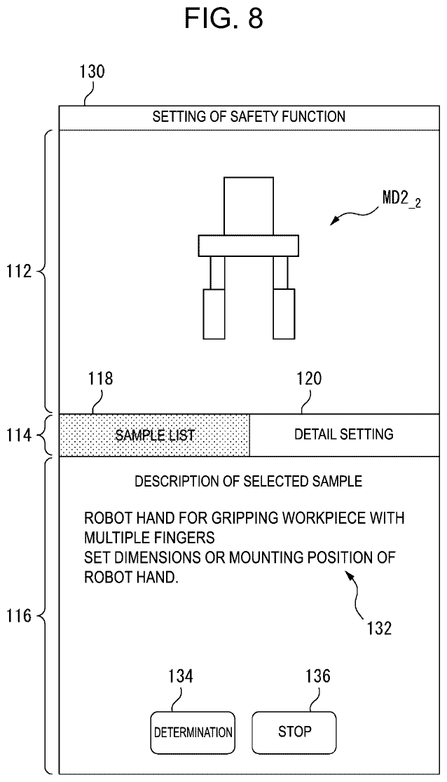

For example, when the operator operates the input device 56 and clicks the button image 126 for selecting the model sample MD′, the processor 50 generates the image data of a sample description image 130 illustrated in FIG. 8 as CG and displays the sample description image 130 on the display device 58 according to the input IP2 for selecting the model sample MD′.

The sample description image 130 is a GUI for describing the sample SP′ selected in the sample selection image 110 in FIG. 7. In the sample description image 130 illustrated in FIG. 8, the processor 50 displays in the first image area 112, the machine model MD2_₂ (specifically, the drawing data MD2__{2A} and the monitoring model MD2__{2B}) included in the selected model sample MD′.

Thus, in the present embodiment, the processor 50 functions as an image generating section 64 (FIG. 2) that generates the image 130 displaying the machine model MD2_₂. Note that in the present embodiment, since the sample set SSₘ is selected in FIG. 6, the machine model MD2_₂ included in the model sample MD′_{1_m} is displayed in the first image area 112. Note that only the monitoring model MD2__{2B} (or drawing data MD2__{2A}) may be displayed in the first image area 112.

On the other hand, in the third image area 116, a determination button image 134 and a stop button image 136 are displayed along with a descriptive text 132 of the machine information MD1 of the model sample MD′_{1_m}. The operator can check the machine information MD1 of the selected model sample MD′_{1_m} and the items that can be set, by viewing the descriptive text 132.

The operator can operate the input device 56 and click the determination button image 134 or the stop button image 136 on the image. Upon receiving an input IP3 to click the stop button image 136, the processor 50 again displays the sample selection image 110 illustrated in FIG. 7 on the display device 58.

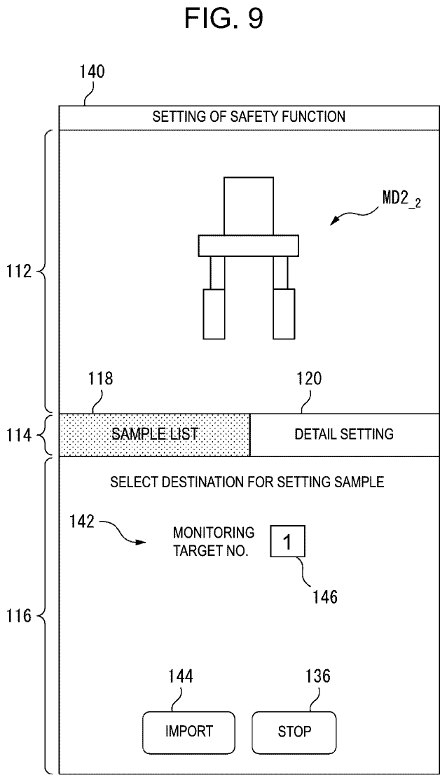

On the other hand, when receiving an input IP4 for clicking the determination button image 134, the processor 50 functions as the image generating section 64 to generate the image data of a sample import image 140 illustrated in FIG. 9 as CG and displays the image data on the display device 58. The sample import image 140 is a GUI for importing the selected sample SP′ to a function FC that sets the safety parameter SP. Here, the function FC for setting the safety parameter SP is implemented as an application in the teaching device 18 and stored as application software in the storage 52.

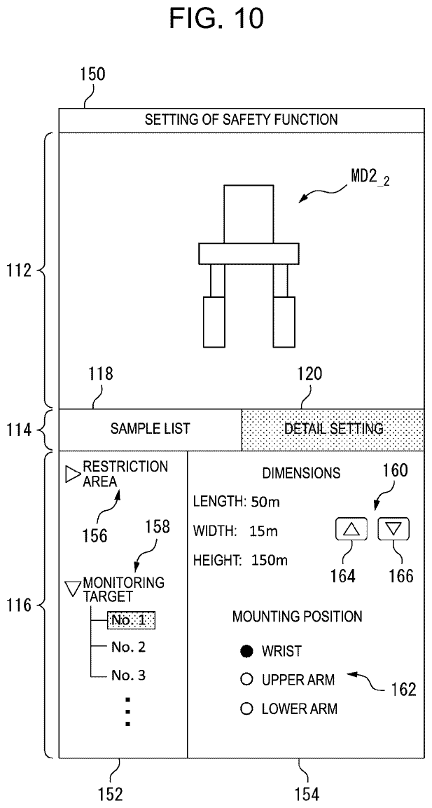

The processor 50 sets a safety parameter FP by performing this function FC. Thus, the processor 50 functions as a parameter setting section 66 (FIG. 2) which sets the safety parameter FP. The function FC (i.e., the function of the parameter setting section 66) for setting the safety parameter SP will be described later with reference to FIG. 10.

In the sample import image 140 illustrated in FIG. 9, the machine model MD2_₂ is displayed in the first image area 112, as in the sample description image 130 illustrated in FIG. 8, while a monitoring target setting image 142, an import button image 144, and the stop button image 136 are displayed in the third image area 116.

The monitoring target setting image 142 is for adding the identification number (or, the address number of the setting destination) N when the selected model sample MD′_{1_m} is imported to the function FC as a monitoring target. Specifically, the monitoring target setting image 142 includes a number input image 146 to input an identification number N. The operator can operate the input device 56 to input the identification number N into the number input image 146. In the example illustrated in FIG. 9, the identification number N: “1” is input to the number input image 146.

The import button image 144 is for importing the selected sample SP′(in FIG. 9, the model sample MD′_{1_m}) to the function FC that sets the safety parameter SP, so that the operator can operate the input device 56 and click the import button image 144 on the image.

Upon receiving an input IP5 via the input device 56 for clicking the import button image 144, the processor 50 reads out the selected sample SP′ from the storage 52 and imports the selected sample SP′ to the function FC. Thus, in the present embodiment, the processor 50 functions as an import section 68 (FIG. 2) that imports the sample SP′.

The processor 50 then functions as the parameter setting section 66 to set the imported sample SP′ as a new safety parameter SP″ to the function FC and store the imported sample SP′ in a second storage area 52B of the storage 52. This second storage area 52B is a storage area of the storage 52, separate from the first storage area 52A for storing the sample SP′ and the sample set SS.

For example, when receiving the input IP5, the processor 50 functions as the import section 68 to read out the sample SP′ from the first storage area 52A of the storage 52. The processor 50 then converts the data format of the read sample SP′ from the first format FM1 to a second format FM2 (extension “.efg”) conforming to the function FC and imports the sample SP′ to the function FC, which may be stored in the second storage area 52B as a temporary safety parameter SP″.

In the case of the example illustrated in FIG. 9, when receiving the input IP5 for clicking the import button image 144, the processor 50 imports the selected model sample MD′_{1_m} to the function FC as the monitoring target for the identification number “1”, which is stored in the second storage area 52B as a new safety parameter SP″.

The processor 50 functions as the image generating section 64 to generate image data of a sample adjusting image 150 illustrated in FIG. 10 as CG and displays the image data on the display device 58. On the other hand, upon receiving the input IP3 to click the stop button image 136, the processor 50 again displays the sample selection image 110 illustrated in FIG. 7 on the display device 58.

The sample adjusting image 150 illustrated in FIG. 10 is a GUI for performing the function FC that sets the safety parameter SP by the input operation of the operator. In the example illustrated in FIG. 10, the first image area 112 displays the machine model MD2_₂ of the imported model sample MD′_{1_m}. In the second image area 114, the detail setting image 120 is highlighted.

On the other hand, a parameter display image 152 and the parameter adjusting image 154 are displayed in the third image area 116. The parameter display image 152 illustrates a list of the safety parameters SP″ newly set in the function FC. Note that the initial safety parameter SP′ before making the adjustments described below is identical to the imported sample SP′.

The parameter display image 152 includes a limited area display image 156 and a monitoring target display image 158. The limited area display image 156 indicates the limited area RE set (i.e., imported) as the safety parameter SP″. The limited area display image 156 will be described later.

The monitoring target display image 158 illustrates the model sample MD′ set as a monitoring target in the safety parameter SP″. For example, in FIG. 9, since the model sample MD′_{1_m} is imported as a monitoring target with the identification number “1”, the model sample MD′_{1_m} is set in the safety parameter SP″ as a monitoring target with the identification number “1”, and is displayed as the monitoring target for “NO. 1” in the monitoring target display image 158.

The operator can import a plurality of model samples MD′ to the function FC along with giving the identification number N by the method described in FIGS. 7 to 9. Each time the model sample MD′ is imported, the monitoring targets displayed in the monitoring target display image 158 increase as “NO. 1”, “NO. 2”, “NO. 3”, . . . , and so on. In this way, the operator can import a plurality of model samples MD′, which are set to the safety parameters SP″ in a form identifiable by the identification number N.

The parameter adjusting image 154 is for adjusting the temporary safety parameter SP″ already set. In the example illustrated in FIG. 10, the parameter adjusting image 154 includes a dimension adjusting image 160 and a mounting position adjusting image 162. The dimension adjusting image 160 adjusts the machine information MD1 of the model sample MD′ set as the safety parameter SP″.

In the present embodiment, the dimension adjusting image 160 can adjust the dimension (e.g., the dimensions, of the fingers of the robot hand 30A, of the suction part of the robot hand 30B, of the welding torch 30C, or of the arm of the welding gun 30D) of the model sample MD′ included in the machine information MD1.

In the example illustrated in FIG. 10, since the “NO. 1” monitoring target is selected in the monitoring target display image 158, the dimension of the model sample MD′_{1_m} as the monitoring target NO. 1 can be adjusted in the dimension adjusting image 160. Specifically, in the dimension adjusting image 160, numerical values of “length,” “width” and “height” are displayed as the dimensions of the model sample MD′_{1_m}, and a numerical value increasing button image 164 and a numerical value decreasing button image 166 are also displayed.

The operator can operate the input device 56 to select the “length”, “width”, or “height” in the dimension adjusting image 160 on the image and to increase or decrease the numerical value of the selected “length”, “width”, or “height” by clicking the numerical value increasing button image 164 or the numerical value decreasing button image 166 on the image. The operator may operate the input device 56 to directly input the numerical value of the “length”, “width”, or “height” without clicking the numerical value increasing button image 164 or the numerical value decreasing button image 166.

On the other hand, the mounting position adjusting image 162 is for adjusting the end effector mounting position included in the machine information MD1 of the model sample MD′. Specifically, in the mounting position adjusting image 162, the “wrist”, “upper arm” and “lower arm” are displayed as the end effector mounting positions, and the operator can select the end effector mounting position on the image from the “wrist”, “upper arm” and “lower arm” by operating the input device 56. For example, in the case of the example illustrated in FIG. 10, since the “wrist” is selected, the end effector mounting position of the selected model sample MD′_{1_m} is set to the wrist 28 of the robot 12.

The processor 50 may be configured to receive the end effector mounting position as a coordinate that indicates the position relative to the “wrist”, “upper arm”, and “lower arm” illustrated in the mounting position adjusting image 162. For example, the processor 50 may further display, in the mounting position adjusting image 162, a coordinate input image for inputting the coordinate (x, y, z) of the robot coordinate system C indicating the position relative to the “wrist”, “upper arm” and “lower arm”. By inputting the coordinate (x, y, z) through the coordinate input image, the operator can set the end effector mounting position to a position separated by that coordinate (x, y, z) from the “wrist”, “upper arm” or “lower arm” selected in the mounting position adjusting image 162. This configuration allows the operator to set the end effector mounting position in more detail.

Thus, the operator operates the input device 56 to give the processor 50 an input IP6 for adjusting the machine information MD1 (dimensions, end effector mounting position) of the model sample MD′_{1_m} set as the temporary safety parameter SP″. The processor 50 functions as the parameter setting section and adjusts the safety parameter SP″ (here, the dimensions of the model sample MD′_{1_m} and the end effector mounting position) according to the received input IP6, thereby updating the safety parameter SP″.

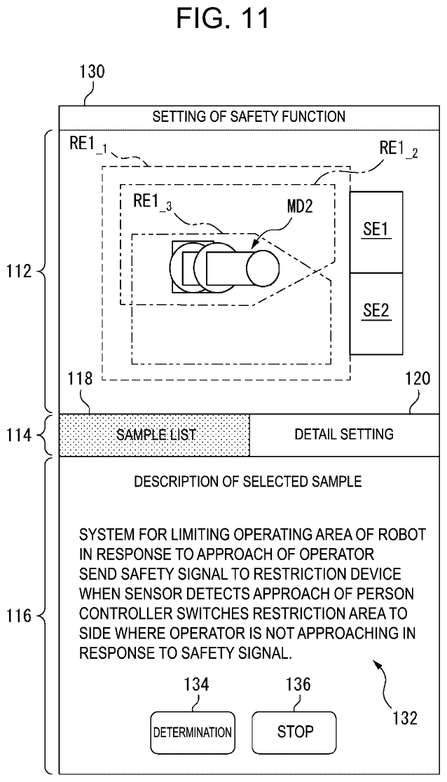

Next, the import of the composite sample CS is described with reference to FIG. 7. When the operator operates the input device 56 and clicks the button image 128 for selecting the composite sample CSₘ, the processor 50 functions as the input receiving section 62 to receive the input IP2 for selecting the composite sample CSₘ, and then functions as the image generating section 64 to generate the image data of the sample description image 130 illustrated in FIG. 11 and display the image data on the display device 58.

In the example illustrated in FIG. 11, the first image area 112 illustrates the first limited area RE1_₁, the second limited area RE1_₂, and the third limited area RE1_₃ (i.e., limit value sample RE1′) contained in the composite sample CSₘ, along with the machine model MD2 of the robot 12. In the first image area 112, the sensor detection areas SE1 and SE2 are displayed. The data of the sensor detection areas SE1 and SE2 (specifically, coordinate in the coordinate system C) may be stored in the composite sample CSₘ as a limit value sample.

By viewing this first image area 112, the operator can easily check the position relationships to the robot 12 of the first limited area RE1_₁, the second limited area RE1_₂, the third limited area RE1_₃, the sensor detection areas SE1 and SE2, which are stored in the composite sample CSₘ. On the other hand, the determination button image 134 and the stop button image 136 are displayed in the third image area 116 along with the descriptive text 132 of the composite sample CSₘ, similar to the sample description image 130 illustrated in FIG. 8.

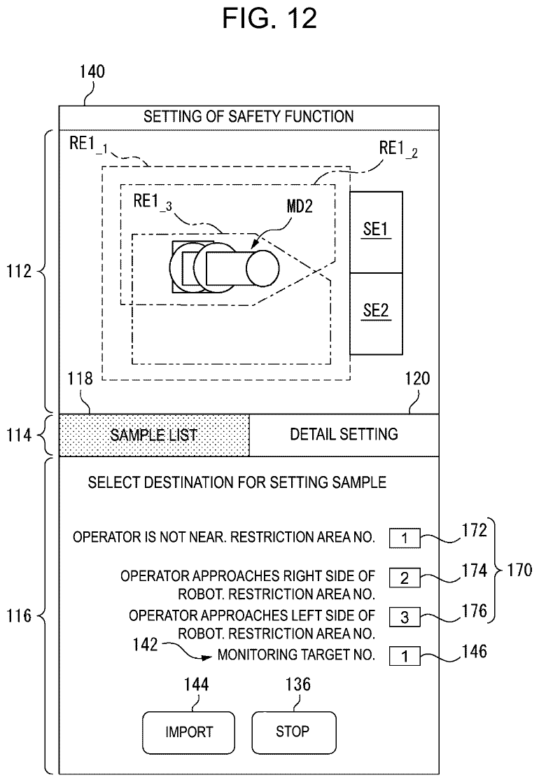

Upon receiving the input IP4, via the input device 56, for clicking the determination button image 134, the processor 50 functions as the image generating section 64 to generate the image data of the sample import image 140 illustrated in FIG. 12 as CG and display the generated image data on the display device 58. In the sample import image 140 illustrated in FIG. 12, the limited areas RE1₁, RE1₂ and RE1_₃, the sensor detection areas SE1 and SE2, and the machine model MD2 are displayed in the first image area 112, similar to the sample description image 130 illustrated in FIG. 11.

On the other hand, the third image area 116 displays a limited area setting image 170, the monitoring target setting image 142, the import button image 144, and the stop button image 136. The limited area setting image 170 is for adding the identification number (or, the address number of the setting destination) N when importing the first limited area RE1_₁, the second limited area RE1_₂ and the third limited area RE1_₃ stored in the composite sample CSₘ to the function FC.

Specifically, the limited area setting image 170 includes a number input image 172 for inputting the identification number N of the first limited area RE1_₁, a number input image 174 for inputting the identification number N of the second limited area RE1_₂, and a number input image 176 for inputting the identification number N of the third limited area RE1_₃.

In the present embodiment, in the limited area setting image 170, the descriptive text of “operator is not near” which explains the first limited area RE1_₁, the descriptive text of “operator approaches right side of robot” which explains the second limited area RE1_₂, and the descriptive text of “operator approaches left side of robot” which explains the third limited area RE1_₃, are listed next to the left of the number input images 172, 174 and 176, respectively.

The operator can operate the input device 56 to input the identification number N into each of the number input images 172, 174 and 176. In the example illustrated in FIG. 12, the identification number N: “1” is input to the number input image 172, the identification number N: “2” is input to the number input image 174, and the identification number N: “3” is input to the number input image 176. On the other hand, the identification number N: “1” is input to the number input image 146 of the monitoring target setting image 142, as in FIG. 9.

When the operator operates the input device 56 and clicks the import button image 144 on the image, the processor 50 receives the input IP5 for clicking the import button image 144, functions as the import section 68, and reads out the data of the first limited area RE1_₁, the second limited area RE1_₂, and the third limited area RE1_₃, which are contained in the composite sample CSₘ, from the storage 52 and imports them to the function FC.

At this time, the processor 50 may read out the composite sample CSₘ (data of the limited areas RE1_₁, RE1_₂ and RE1_₃) from the first storage area 52A, convert the data format of the composite sample CSₘ from the first format FM1 to the second format FM2, import the converted composite sample CSₘ to the function FC, and store the converted composite sample CSₘ in the second storage area 52B. The processor 50 then functions as the parameter setting section 66 to set the imported composite sample CSₘ (data of the limited areas RE1_₁, RE1_₂ and RE1_₃) as a new safety parameter SP″ into the function FC.

In the case of the example illustrated in FIG. 12, when receiving the input IP5, the processor 50 imports, to the function FC, the first limited area RE1_₁ as a limited area with the identification number “1” (limited area NO. 1), the second limited area RE1_₂ as a limited area with the identification number “2” (limited area NO. 2), and the third limited area RE1_₃ as a limited area with the identification number “3” (limited area NO. 3).

Along with this, the processor 50 sets the monitoring target NO. 1 (FIG. 10) set in the safety parameter SP″ as the monitoring target for the imported limited area NO. 1 (i.e., the first limited area RE1_₁), limited area NO. 2 (i.e., the second limited area RE1_₂), and limited area NO. 3 (i.e., the third limited area RE1_₃).

Thus, the processor 50 sets the imported limited areas NO. 1 to 3 (i.e., data of the limited areas RE1_₁, RE1_₂, and RE1_₃, which are the limit value sample RE1′) as a new safety parameter SP″ for the imported monitoring target NO. 1 (model sample MD′_{1_m}). Thus, the operator can specify the monitoring targets NO. N (N=1,2,3 . . . ), which are imported to the function FC and whose dimensions are edited, as the monitoring target for the limited areas NO. 1, NO. 2 and NO. 3, which are imported to the function FC.

When the identification number N (e.g., N=16) of the monitoring target not imported to the function FC is input into the number input image 146 in FIG. 12, and the import button image 144 is clicked, the processor 50 may newly import, to the function FC, the model sample MD′_{1_m} stored in the sample set SSₘ, as the monitoring target NO. 16. In this case, the monitoring target NO. 16 is newly added to the monitoring target display image 158 (FIG. 10) and set to the monitoring target for the imported limited areas NO. 1, NO. 2 and NO. 3.

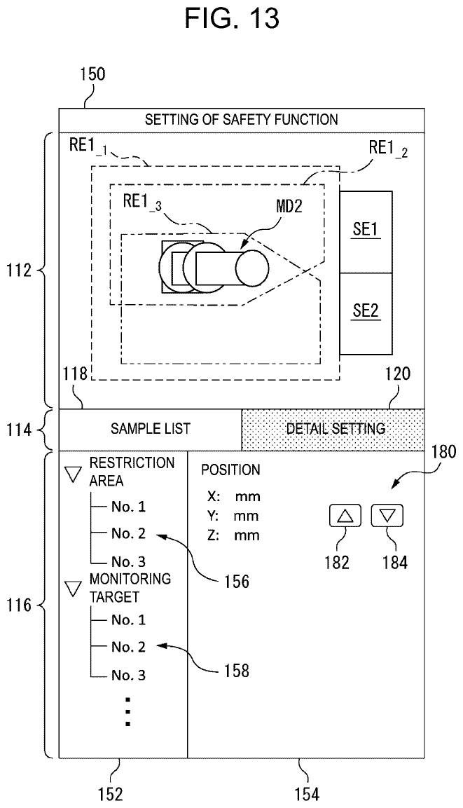

The processor 50 then functions as the image generating section 64 to generate the image data of the sample adjusting image 150 illustrated in FIG. 13 as CG, which is displayed on the display device 58. In the sample adjusting image 150 illustrated in FIG. 13, the imported composite sample CSₘ (the limited areas RE1_₁, RE1_₂ and RE1_₃, and the sensor detection areas SE1 and SE2) and the machine model MD2 are displayed in the first image area 112, as in FIG. 11.

On the other hand, in the parameter display image 152 of the third image area 116, the imported monitoring targets NO. 1, NO. 2, and NO. 3, . . . are displayed in the monitoring target display image 158, and the imported limited area NO. 1 (first limited area RE1_₁), limited area NO. 2 (second limited area RE1_₂), and limited area NO. 3 (third limited area RE1_₃) are displayed in the limited area display image 156.

Although not illustrated, for the sensor detection areas SE1 and SE2, the processor 50 may also receive an input of the identification number N, as well as the limited areas NO. 1 to 3, through the sample import image 140 illustrated in FIG. 12, and may display the sensor detection areas SE1 and SE2 imported to the function FC in the limited area display image 156.

The parameter adjusting image 154 in the third image area 116 illustrates an area adjustment image 180. The area adjustment image 180 is for adjusting the parameters (specifically, coordinates of the coordinate system C) of the limited area NO. 1, NO. 2, or NO. 3 set as a temporary safety parameter SP″ and includes a numerical value increasing button image 182 and a numerical value decreasing button image 184. The functions of the area adjustment image 180 will be described below.

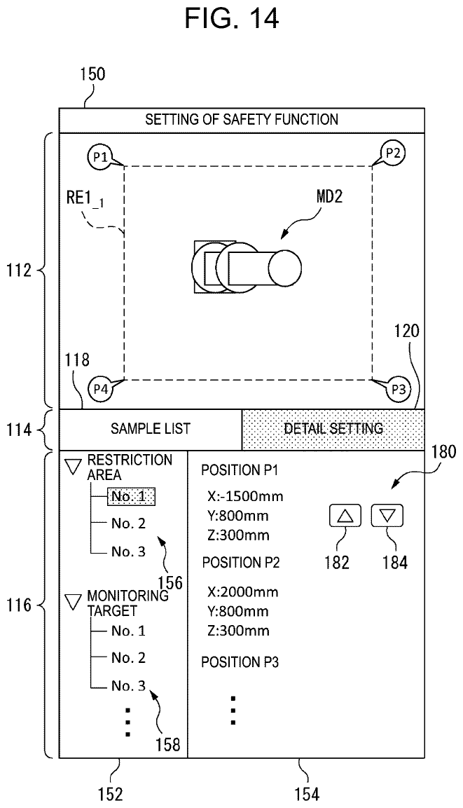

The operator can edit the limited area NO. 1, NO. 2, or NO. 3 arbitrarily through the area adjustment image 180. For example, when the operator operates the input device 56 to select the limited area NO. 1 in the limited area display image 156 on the image, the processor 50 generates the sample adjusting image 150 illustrated in FIG. 14 and displays the generated sample adjusting image 150 on the display device 58. In the example illustrated in FIG. 14, the limited area NO. 1 is highlighted to visually indicate that the limited area NO. 1 is selected in the limited area display image 156.

Further, in the first image area 112, only the selected limited area NO. 1 (i.e., first limited area RE_₁) is displayed together with the machine model MD2 and a plurality of apexes P1, P2, P3, and P4 defining the limited area NO. 1 (first limited area RE1_₁) are visibly displayed. The coordinates (x, y, z) of “position P1”, “position P2”, “position P3” and “position P4” corresponding to the apexes P1, P2, P3, and P4 of the limited area NO. 1 are respectively displayed in a parameter adjusting image 154.

The operator can operate the input device 56 and select one of the coordinates (x, y, z) of the positions P1 to P4 on the image, and the coordinate value of the selected coordinate (x, y, z) can be increased or decreased by clicking the numerical value increasing button image 182 or numerical value decreasing button image 184 on the image. The operator may operate the input device 56 to directly input the coordinate value of the coordinate (x, y, z) without clicking the numerical value increasing button image 182 or the numerical value decreasing button image 184. As a result, the parameter (coordinate) of the limited area NO. 1 is adjusted.

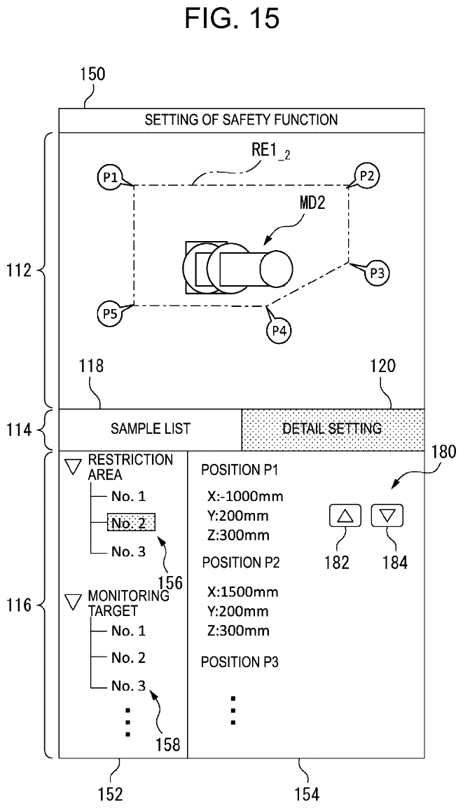

On the other hand, when the operator operates the input device 56 and selects the limited area NO. 2 indicated in the limited area display image 156 on the image, the processor 50 generates the sample adjusting image 150 illustrated in FIG. 15 and displays the generated sample adjusting image 150 on the display device 58. Similar to the adjustment of the parameters of the limited area NO. 1, the operator can operate the input device 56 to adjust the coordinate (x, y, z) of each apex P1 to P5 of the limited area NO. 2 through the sample adjusting image 150 illustrated in FIG. 15.

Thus, the operator operates the input device 56 to give the processor 50 an input IP6 for adjusting the limited areas NO. 1 to NO. 3 set as the temporary safety parameter SP″. The processor 50 functions as the parameter setting section and adjusts the temporary safety parameter SP″ (here, the coordinates of the limited areas NO. 1 to 3) in response to the received input IP6, thereby updating the safety parameter SP″.

The processor 50 may adjust the coordinates of the sensor detection areas SE1 and SE2 as well as the limited areas NO. 1 to 3 in response to the input from the input device 56 by the operator. The processor 50 may also adjust the limited area switching information SI that defines the relationship between “ON”/“OFF” of the safety signals S1 and S2 and valid/invalid of the second limited area RE1_₂ and the third limited area RE1_₃ in response to an input from the input device 56 by the operator. In this case, the processor 50 may display an image for adjusting the coordinates of the sensor detection areas SE1 and SE2 or the limited area switching information SI in the parameter adjusting image 154.

Again, referring to FIG. 7, the operator can select the limit value sample RE1′_ₘ or RE2′_ₘ contained in the sample set SSₘ, which is then imported to the function FC by operating the input device 56 and clicking button image 122 or 124, as with the composite sample CSₘ described above.

For example, when the limit value sample RE1′_ₘ or RE2′_ₘ is selected, the third image area 116 of the sample import image 140 illustrated in FIG. 12 displays one number input image 172 for specifying the identification number N of the limit value sample RE1′_ₘ or RE2′_ₘ and the number input image 146.

When the import button image 144 is clicked, the processor 50 functions as the import section 68 and adds the identification number N entered in the number input image 172 to the limit value sample RE1′_ₘ or RE2′_ₘ, and set the limited area NO. N as a new safety parameter SP″.

In this way, the operator can import the prepared sample SP′(specifically, the sample set SS containing a plurality of samples SP′) to the function FC and set the safety parameter SP″ in the function FC based on the imported sample SP′.

After setting and adjusting the safety parameter SP″, the operator inputs a command to apply the safety parameter SP″ set by the function FC to an operating condition OC to operate the machine 36 in actual work. For example, the processor 50 displays, in the sample adjusting image 150, an application button image (not illustrated) for applying the safety parameter SP″ to the operating condition OC.

When the operator operates the input device 56 and clicks the apply button image on the image, the processor 50 receives an input IP7 of the application button image through the input device 56, and registers in the operating condition OC, the safety parameter SP″ set at this time as the formal safety parameter SP.

In the operating condition OC, the safety parameter SP as well as the conditions required to operate the machine 36 in the actual work may be registered. The processor 50 may store the operating condition OC as data in the second format FM2 in the second storage area 52B (or a third storage area 52C for the operating condition OC) of the storage 52.

Alternatively, the processor 50 may store the operating condition OC in the second storage area 52B (or the third storage area 52C) as data in a third format FM3 (Extension: “.xyz”). In this case, when receiving the input IP7, the processor 50 may convert the data format of the safety parameter SP″ from the second format FM2 to the third format FM3 and register the converted safety parameter SP″ in the operating condition OC as a formal safety parameter SP. Thus, the operator can set the safety parameter SP by using the function FC.

As described above, the processor 50 functions as the input receiving section 62, the image generating section 64, the parameter setting section 66, and the import section 68, and sets the safety parameter SP based on the samples SP′ stored in the storage 52. Thus, the processor 50 (input receiving section 62, image generating section 64, parameter setting section 66, import section 68) and the storage 52 constitute a device 70 (FIG. 2) that sets the safety parameter SP.

In this device 70, the storage 52 stores at least one prepared sample SP′, the input receiving section 62 receives the input IP2 for selecting the sample SP′ stored in the storage 52, the import section 68 reads out the selected sample SP′ (model sample MD, composite sample CSₘ) through the input receiving section 62 from the storage 52 and imports the selected sample SP′ to the parameter setting section 66 (function FC), and the parameter setting section 66 sets the imported sample SP′ as a new safety parameter SP″.

According to the device 70, the operator can easily build a framework of the safety parameter SP (limited area RE, or the like) for the machine 36 simply by selecting the desired samples SP′ from the prepared sample SP′ for the actual machine 36. Thus, the work of setting the safety parameter SP is greatly simplified compared to the methods in the related art of setting the safety parameter SP from the beginning one by one.

Additionally, in the device 70, the parameter setting section 66 adjusts the set safety parameter SP″ (dimensions of the model sample MD′_{1_m}, the end effector mounting position, and the coordinates of the limited areas NO. 1 to 3) according to the input IP6 received by the input receiving section 62.

According to this configuration, since the operator can adjust the imported sample SP′ appropriately so as to correspond to the actual machine 36 and then set the adjusted sample SP′ as the formal safety parameter SP, the safety parameter SP can be set more easily for various forms of the machine 36.

Further, in the device 70, the input receiving section 62 receives the input IP1 for selecting the sample set SS stored in the storage 52 and the input IP2 for selecting the sample SP′ stored in the selected sample set SS. According to this configuration, the operator can set the safety parameter SP by using the sample set SS that includes a set of several types of samples SP, thus making it easier to set the safety parameter SP.

In addition, in the device 70, data of a plurality of safety parameters SP (first limited area RE1_₁, second limited area RE1_₂, third limited area RE1₃) are combined and stored in the composite sample CS as one sample, and the parameter setting section 66 sets the data stored in the imported composite sample CS as new safety parameters SP″. With this configuration, the safety parameter SP for achieving the safety function described with reference to FIG. 5, can be easily set.

Further, in the device 70, the import section 68 reads out, from the storage 52, the limit value sample (data of the limited areas RE1_₁, RE1_₂ and RE1_₃, stored in the composite sample CS) and the model sample MD′_{1_m}, which are selected through the input receiving section 62, and imports them to the parameter setting section 66, and then the parameter setting section 66 sets the imported limit value samples RE1_₁, RE1_₂ and RE1_₃ as anew safety parameter SP″ and sets them for the imported model sample MD′_{1_m}. With this configuration, the operator can easily set the imported model sample MD′_{1_m} as a monitoring target by the imported limit value samples RE1_₁, RE1_₂ and RE1_₃.

Further, in the device 70, when the input receiving section 62 receives the input IP2 for selecting the model sample MD′, the image generating section 64 generates the image 140 displaying the machine models MD2 and MD2_₂ included in the model sample MD′. With this configuration, the operator can easily check the type and structure of the selected model sample MD′.

Further, in the device 70, the parameter setting section 66 sets the safety parameter SP″ to the operating condition OC according to the input IP7 received by the input receiving section 62. With this configuration, the operator can easily register the safety parameter SP″ set based on the sample SP′ in the operating condition OC as the formal safety parameter SP.

In the above-described embodiment, the case has been described where the storage 52 stores the sample set SS and the processor 50 receives the input IP1 for selecting the sample set SS through the sample set selection image 100 illustrated in FIG. 6. However, the present disclosure is not limited to this configuration, and the storage 52 may only store the sample SP′ (the limit value samples RE1′, RE2′, V and PT′, the model sample MD′ and the composite sample CS) without storing the sample set SS.

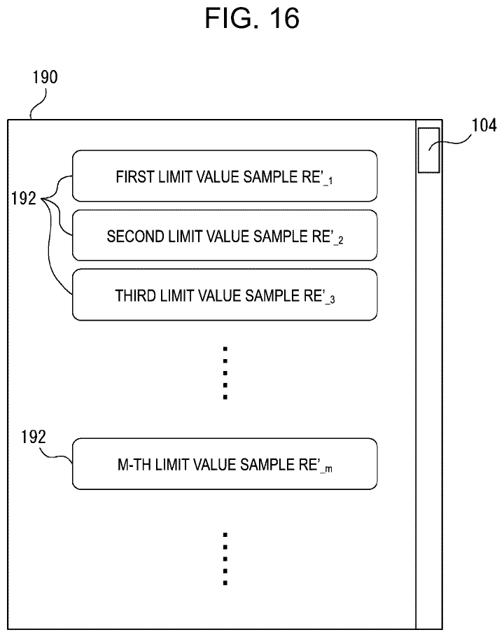

Such a configuration is described below. In the present embodiment, when receiving a setting start command, the processor 50 generates image data of the sample selection image 110 illustrated in FIG. 7 and displays the generated image on the display device 58. Then, when functioning as the input receiving section 62 and receiving from the input device 56 the input IP2 to click the button images 122, 124, 126 or 128, the processor 50 generates image data of a sample list image 190 illustrated in FIG. 16 and displays the generated image on the display device 58.

FIG. 16 illustrates an example of the sample list image 190 when the operator clicks the button image 122 (limit value sample RE1′) in FIG. 7. The sample list image 190 includes a plurality of sample selection button images 192 and the scroll bar image 104. A plurality of sample selection button images 192 are respectively associated with the first limit value sample RE1′_₁, the second limit value sample RE1′_₂, . . . the m-th limit value sample RE1′_ₘ, which are stored in the storage 52. The operator can also change the limit value sample RE1′ displayed by sliding the scroll bar image 104 on the image.

For example, when the operator operates the input device 56 and clicks a sample selection button image 192 corresponding to the m-th limit value sample RE1′_ₘ on the image, the processor 50 generates the sample import image 140 for the m-th limit value sample RE1′_ₘ as illustrated in FIG. 12.

In this sample import image 140, the selected m-th limit value sample RE1′_ₘ is displayed in the first image area 112, and the number input image 172 and the number input image 146 for inputting the identification number N to be added to the m-th limit value sample RE1′_ₘ are displayed in the third image area 116.

Supposing that the operator inputs N=5 in the number input image 172 and N=6 in the number input image 146, and clicks the import button image 144, the processor 50 imports the m-th limit value sample RE1′_ₘ to the function FC as the limited area NO. 5 in response to input IP5 by clicking the import button image 144, and sets the monitoring target NO. 6 set in the safety parameter SP″ as the monitoring target for the imported limited area NO. 5. Thus, the m-th limit value sample RE1′_ₘ can be imported and set to the safety parameter SP″.

It should be understood that when the operator selects another button image 124 (limit value sample RE2′), 126 (model sample MD′), or button image 128 (composite sample CS), which are illustrated in FIG. 7, the processor 50 can import the selected sample SP′(RE2′, MD′, CS) in the same manner.

The processor 50 may function as the parameter setting section 66 to automatically adjust the imported limit value sample RP′ in response to the machine information MD1 included in the model sample MD′ imported to the function FC. Specifically, the machine information MD1 of the model sample MD′ further includes the identification number ID to identify the type of main body of the robot 12, or the maximum arrival distance d_{MAX} of the robot 12.

Then, after importing the model sample MD′, the processor 50 automatically adjusts the coordinate of the limit value sample RE1′ or RE2′(including the data stored in the composite sample CS) according to the identification number ID or the maximum arrival distance d_{MAX} when the limit value sample RE1′ or RE2′ is imported through the sample import image 140 illustrated in FIG. 12.

As an example, the processor 50 automatically adjusts the coordinates of the imported limit value sample RE1′ or RE2′ based on the coordinates and the maximum arrival distance d_{MAX} so that the limited area RE1 or RE2 represented by the limit value sample RE1′ or RE2′ falls within the maximum arrival distance d_{MAX}.

As another example, the storage 52 further stores a data table DT in which the identification number ID, and the coordinates of the limited areas RE1 or RE2 conforming to the robot 12 identified by the identification number, are stored in association with each other. Then, the processor 50 acquires the identification number ID when importing the model sample MD′, and reads out, from the data table DT, the coordinates of the limited area RE1 or RE2 corresponding to the identification number ID.

The processor 50 then automatically adjusts the coordinates of the imported limit value sample RE1′ or RE2′ based on the read coordinates (for example, so as to match with the read coordinates). In this way, the processor 50 (parameter setting section 66) can automatically adjust the imported limit value samples RE1′, RE2′ in response to the machine information MD1. This configuration further simplifies the work of setting the safety parameter SP.

Note that in the above embodiment, when importing the model sample MD′, the processor 50 may automatically retrieve the limit value sample RP′, the composite sample CS, or the sample set SS conforming to the acquired identification number ID or the maximum arrival distance d_{MAX} from the storage 52. When receiving the input IP1 or the IP2, the processor 50 may display the retrieved limit value sample RP′, composite sample CS, or sample set SS in the sample set selection image 100 illustrated in FIG. 6 or the sample list image 190 illustrated in FIG. 16.

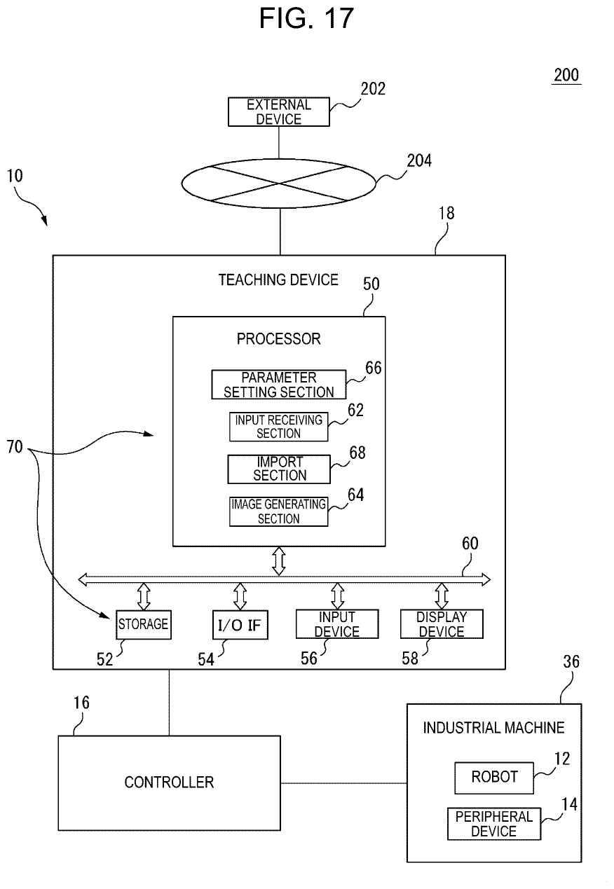

Next, with reference to FIG. 17, a network system 200 according to one embodiment will be described. The network system 200 includes the mechanical system 10, an external device 202, and a network 204. The external device 202 is, for example, an external server, which is a computer including a processor and a storage device.

The network 204 is, for example, a LAN (intranet, or the like) or the Internet that communicably connects the external device 202 and the teaching device 18 (specifically, I/O interface 54). The external device 202 and the controller 16 may be connected via the network 204, and the teaching device 18 may be connected to the external device 202 via the controller 16 and the network 204.

For example, the external device 202 is located in a first facility, while the mechanical system 10 is located in a second facility, away from the first facility. The sample SP′ or the sample set SS described above is created with the external device 202. The external device 202 then transmits the sample SP′ or the sample set SS to the teaching device 18 via the network 204 in response to a request from the controller 16 or the teaching device 18.

The processor 50 of the teaching device 18 acquires the sample SP′ or the sample set SS through the I/O interface 54, which is then stored in the storage 52. Thus, the sample SP′ or the sample set SS is prepared before setting the safety parameter SP. According to this configuration, when the operator of the external device 202 sequentially updates the sample SP′ or the sample set SS, the operator of the mechanical system 10 can acquire the latest sample SP′ or the sample set SS suitable for the real machine 36 from the external device 202 at any time through the network 204.

The external device 202 is not limited to an external server and may be an external memory (such as a flash memory). In this case, the external memory stores the sample SP′ or the sample set SS and is connected to the I/O interface 54. The processor 50 then acquires the sample SP′ or the sample set SS from the external device 202 as an external memory in response to the input from the operator, which is then stored in the storage 52.

In the above embodiment, when the processor 50 sets anew safety parameter SP″ based on the sample SP′, the new safety parameter SP″ may be used to simulate the operation of the machine 36. Specifically, in response to the input from the operator, the processor 50 generates, for example, the machine model MD2 (e.g., drawing data) illustrated in the first image area 112 of FIG. 13 and the limited areas RE1_₁, RE1_₂ and RE1_₃ in the three-dimensional virtual space.

On the other hand, the processor 50 acquires the operation program OP of the machine 36 and operates the machine model MD2 in the virtual space simulatively according to the operation program OP. At this time, the limitation parameter RP set in the safety parameter SP″ is applied to the operation of the machine 36. Through such simulations, the operator can determine the suitability of the newly set safety parameter SP″ based on the sample SP′.

In the above embodiment, the case where the model sample MD′ of the end effector 30 is set as the monitoring target, has been described. However, the present disclosure is not limited to this configuration, and any part of the main body of the robot 12 (robot base 20, rotary barrel 22, lower arm 24, upper arm 26, or wrist 28) can be set as a monitoring target.

In this case, for example, an image for selecting the main body part of the robot 12 as a monitoring target may be displayed in the sample adjusting image 150 illustrated in FIG. 10 or FIG. 13. In the machine model MD2 illustrated in the first image area 112 in FIGS. 11 to 15, the part set as the monitoring target (robot base 20, rotary barrel 22, lower arm 24, upper arm 26, wrist 28, or end effector 30) may be highlighted in a visually recognizable form (coloring, or the like).

In the above embodiment, the case of selecting the limit value sample RE1′, the limit value sample RE2′, the model sample MD′, or the composite sample CS in the sample selection image 110 illustrated in FIG. 7, has been described. However, the limit value sample V or PT′ may be added to the sample selection image 110, the processor 50 may be configured to import the limit value sample V or PT′ to the function FC. It should be understood that the limit value sample V or PT′ can also be imported in the manner described above, as well as the limit value samples RE1′ and RE2′ and the composite sample CS.

In addition, it should be understood that, in the above embodiment, the case of importing the model sample MD′ of the end effector 30 has been described, but the model sample MD′ of the main body of the robot 12 or of the peripheral device 14 can be imported by the above method.

In this case, the storage 52 stores multiple for each of: the model sample MD′ of the robot 12 or the peripheral device 14; and the limit value sample RP′ or the composite sample CS for the model sample MD′ of the robot 12 or the peripheral device 14.

The processor 50 then imports the model sample MD′, and the limit value sample RP′ or the composite sample CS according to the input from the operator, and sets the imported limit value sample RP′ or the composite sample CS as a new safety parameter SP″ for the model sample MD′ of, the main body of the imported robot 12 or the peripheral device 14.

Further, to prevent interference between the robot 12 and the peripheral device 14, the processor 50 may set the area of the model sample MD′ of the imported peripheral device 14 to the limited area RE2 in the safety parameter SP″ in response to the input from the operator. In this case, for example, in the sample adjusting image 150 illustrated in FIG. 13, the setting image for setting the area of the model sample MD′ of the peripheral device 14 to the limited area RE2, may be displayed.

In addition, in the above embodiment, the data of the limited area RE2 where the robot 12 is prohibited to enter may be stored in the composite sample CS. Additionally, the first image area 112 may be omitted from the images 110, 130, 140, and 150 illustrated in FIGS. 7 to 18 above. Also in this case, the operator can select sample SP′ which is then imported to the function FC. That is, in this case, the image generating section 64 can be omitted from the device 70.

In the above embodiment, a case has been described where the newly set safety parameter SP″ is adjusted according to the input IP6 by the parameter setting section 66. However, the present disclosure is not limited to this configuration, a function to adjust the new safety parameter SP″ can be demanded to a different device from the device 70. In this case, the device 70 sends the newly set safety parameter SP″ to the other device. Alternatively, the sample SP′ imported as the safety parameter SP″ can be used as the safety parameter SP without adjustment.

In the above embodiment, the parameter setting section 66 sets a new safety parameter SP″ to the operating condition OC according to the input IP7 received by the input receiving section 62. However, the present disclosure is not limited to this configuration, a function to set the new safety parameter SP″ to the operating condition OC, can be demanded to a different device than the device 70.

In the above embodiment, the case where the safety parameter SP includes the model data MD, is described. However, the model data MD need not necessarily be included in the safety parameter SP. Thus, the storage 52 does not have to store the model sample MD′. The safety parameter SP is not limited to limiting the operation of the machine 36 (e.g., robot 12) such as the limitation parameter RP, but may include parameters for securing the communication of the controller 16, for example.

Further, in the above embodiment, the processor 50 may function as the import section 68 and import the sample SP′ to the function FC as data in the same data format (specifically, the second format FM2 or the third format FM3) as the formal safety parameter SP registered in the operating condition OC.

In addition, the method of setting the safety parameter SP by using the GUI illustrated in FIGS. 6 to 16 is only an example, and the present disclosure is not limited to this. For example, the process of adding an identification number in the sample import image 140 illustrated in FIG. 9 or FIG. 12 may be omitted, and the process of setting the imported model sample MD′ as the monitoring target for the imported limitation sample RP′ or composite sample CS, may be any process.

In the above embodiment, the case where the device 70 is incorporated into the teaching device 18, is described. However, the present disclosure is not limited to this configuration, the device 70 may be incorporated into the controller 16 or any other computer (desktop or tablet PC). In this case, the processor and the storage of the controller 16 or of another computer would constitute the device 70.

In the above embodiment, the robot coordinate system C is used as a reference of the limit value sample RP′. However, the present disclosure is not limited to this configuration, any coordinate system may be used as a reference for the limit value sample RP′, for example, such as a peripheral device coordinate system C set in the peripheral device 14 to control the peripheral device 14, a work coordinate system set for the workpiece, a world coordinate system defining the three-dimensional space of the work cell, or the like. The present disclosure has been described through the embodiments above, but the above embodiments do not limit the invention claimed in the present patent.

### REFERENCE SIGNS LIST

10: Mechanical system
12: Robot
14: Peripheral device
16: Controller
18: Teaching device
30: End effector
50: Processor
52: Storage
62: Input receiving section
64: Image generating section
66: Parameter setting section
68: Import section
70: Device

1. A device comprising:
a parameter setting section configured to set a safety parameter for ensuring safety of work performed by a machine;
a storage configured to store a sample of the safety parameter, which is prepared in advance;
an input receiving section configured to receive an input for selecting the sample stored in the storage; and
an import section configured to read out from the storage the sample selected through the input receiving section and import it to the parameter setting section,
wherein the parameter setting section sets the imported sample as a new safety parameter.

2. The device of claim 1, wherein the input receiving section further receives an input for adjusting the new safety parameter, and
wherein the parameter setting section adjusts the set new safety parameter in response to the input for adjusting the new safety parameter received by the input receiving section.

3. The device of claim 1, wherein the storage stores a sample set in which the sample of a first type of the safety parameter and the sample of a second type of the safety parameter are contained, and
wherein the input receiving section receives the input for selecting the sample set stored in the storage, and the input for selecting the sample contained in the selected sample set.

4. The device of claim 1, wherein data of a plurality of the safety parameters are combined to be contained in one sample, and
wherein the parameter setting section sets the data contained in the imported one sample as the new safety parameter.

5. The device of claim 1, wherein the safety parameter includes:
a limitation parameter for determining a limited area where the machine is allowed or prohibited to enter during the work, or a limited speed of the machine during the work; and
a model data of the machine,
wherein the storage stores the sample of the limitation parameter as a limit value sample, and stores the sample of the model data as a model sample,
wherein the input receiving section receives the input for selecting the limit value sample and model sample stored in the storage,
wherein the import section reads out from the storage the limit value sample and model sample selected through the input receiving section and imports them to the parameter setting section, and
wherein the parameter setting section sets, as the new safety parameter, the imported limit value sample for the imported model sample.

6. The device of claim 5, wherein the model sample includes a machine model modeling the machine, and
wherein the device further includes an image generating section configured to generate an image displaying the machine model when the input receiving section receives the input for selecting the model sample.

7. The device of claim 5, wherein the model sample includes machine information representing a type or specification of the machine, and
wherein the parameter setting section automatically adjusts the imported limit value sample in response to the machine information included in the imported model sample.

8. The device of claim 1, wherein the input receiving section further receives an input for applying the new safety parameter set by the parameter setting section to an operating condition for operating the machine in the work, and
wherein the parameter setting section sets the new safety parameter to the operating condition in response to the input for applying the new safety parameter to the operating condition, received by the input receiving section.

9. A teaching device for the machine, comprising the device of claim 1.

10. A method of setting a safety parameter for ensuring safety of work performed by a machine, the method comprising:
storing a sample of the safety parameter, which is prepared in advance, in a storage;
performing, by a processor, a function of setting the safety parameter;
receiving, by the processor, an input for selecting the sample stored in the storage;
reading out, by the processor, from the storage the sample selected by the input and importing it to the function; and
setting, by the processor, the imported sample as a new safety parameter.
